(19) United States
(12) Patent Application Publication
(10) Pub. No.: US 2014/0185820 A1
(43) Pub. Date: Jul. 3, 2014

(54) Ear Bud Retraction Mechanism Having a Break Away Dust Door

(71) Applicant: HEADLOGIC LLC, (US)

(72) Inventors: John Cataldo, Westlake Village, CA (US); Daniel C. Sullivan, Santa Barbara, CA (US); Mardis Bagley, San Francisco, CA (US)

(73) Assignee: HEADLOGIC LLC, Westlake Village, CA (US)

(21) Appl. No.: 13/733,630

(22) Filed: Jan. 3, 2013

(51) Int. Cl. H04R 1/10

(52) U.S. Cl. CPC H04R 1/1033
USPC 381/74

(57) ABSTRACT

A retractable ear bud module, comprising: a housing having a cover and a door with a hinge for removably attaching the door to the cover; the cover includes a side defining a curved depression for removably holding the hinge; a retraction mechanism including a rotatable spool having an axis, and an ear bud cable mounted in the housing, the retraction mechanism selectively retracts or dispenses the ear bud cable; at least one ear bud attached to the ear bud cable; a wireless receiver for receiving audio signals, the wireless receiver being in electronic communication with the ear bud cable to communicate audio signals to at least one ear bud.

### RELATED APPLICATIONS

This patent application relates in subject matter to commonly assigned U.S. patent application Ser. No. 13/621,332, filed 17 Sep. 2012, and U.S. patent application Ser. No. 13/733,574, filed 3 Jan. 2013, the disclosures of which is incorporated herein by reference.

### FIELD OF THE INVENTION

The present invention relates to ear bud management mechanisms that dispense and retract ear bud cables, and cases that are connectable with ear bud management mechanisms.

### BACKGROUND OF THE INVENTION

Ear buds are devices that attach to the ear or head of a user to deliver sound directly to the ear in a personal way. Ear buds may attach to the pinna, lobule, or insert within the external auditory canal. Ear buds may also hang from the head and cover a portion of the ear. The sound delivered typically can be heard by the user, but others have difficulty hearing at the typical sound volume delivered.

One benefit of using ear buds is that an electronic device may be distanced from a user's ear to minimize electro-magnetic fields, which are known to impair the electrical fields in the brain, sometimes causing headaches or heat buildup in the head. Another benefit is to minimize interference with ambient sounds. Yet another benefit is to minimize eavesdropping. Since an ear bud need not be held by a user, this frees the hands for other activities.

Ear buds are commonly used with telephones, music players, computers and other portable and non-portable electronic devices.

One major drawback of using wired ear buds with electronic devices is cord management. Cord management is a commonly experienced problem where the cord of the ear buds becomes tangled. Ear bud cords may be damaged by a frustrated user who attempts to hastily untangle the cord. Operating an automobile or other vehicle while experiencing cord management problems can be dangerous. What is desired is a better way of cord management which enables the user to readily extend and retract ear bud cables in an easy and reliable manner.

GB 2486215 to KO-An Chen et al. discloses a slider case 1 with a cable retractor defines a space 11 for a portable appliance such as a mobile phone, a notebook or tablet computer. A base plate 6 is positioned between the space 11 and the casing 1 to define a thin space housing a cable retractor comprising a rotary disc 3 with an indentation 31 housing a coil spring 2, a cable 4 and a winding disc 5 with a central axle 52 for the winding of the cable. Inter-engaging gear teeth are 34, 51 are provided around the rotary and winding discs such that retraction of the cable causes winding of the spring. A flip-open cover 7 covers an opening for cable connectors 42, 421. The lateral relative location of discs 3 and 5 allows for a relatively thin retractor space.

One drawback of currently marketed ear bud cable retraction devices is the entry of contaminants, including dust, dirt and other small objects. Contaminants may increase friction between the ear bud cable and the winding disc, between the winding disc and the housing, and may reduce the life of the enclosed electronics.

Another drawback is the durability of the ear bud cable itself. Many times, cable becomes snagged and pulling the cable with sufficient force may deform, or even destroy the cable. For example, a cable snagged in a car door may snap if it is yanked or pulled with sufficient force. One reason for this is that stress points occur where the cable enters the housing, and in other areas where the cable incurs friction with the housing.

While the state of the art shows a trend toward convenience of use of ear buds with electronic devices and cases for electronic devices, there is also a lack of effective ways for managing ear bud cables that have a desired degree of reliability and endurance. What is desired is a way of managing ear bud cables that is convenient, safe and durable. In addition, it is also desirable that the ear bud management device is sufficiently protected from the ingress of dust and other contaminants.

### SUMMARY OF THE INVENTION

A retractable ear bud module solves insufficiencies of the prior art by providing a resilient door mechanism that cooperates with an asymmetrical bridge mechanism to inhibit entry of contaminants into the module. This includes the ability to fix the door in a closed configuration, and enable the door in an open configuration to break-away upon impact or pressure. The break-away mechanism enables rapid replacement of the door after it has broken away. Accordingly, the ability of the module to resist contaminants such as dust and other objects is improved, even after the door has been forcibly removed, and replaced.

The retractable ear bud module has a housing having a cover and a door with a hinge for removably attaching the door to the cover; the cover includes a side defining a curved depression for removably holding the hinge; a retraction mechanism including a rotatable spool having an axis, and an ear bud cable mounted in the housing, the retraction mechanism selectively retracts or dispenses the ear bud cable; at least one ear bud attached to the ear bud cable; a wireless receiver for receiving audio signals, the wireless receiver being in electronic communication with the ear bud cable to communicate audio signals to at least one ear bud.

The housing includes an asymmetrical bridge for guiding the ear bud cable with respect to the spool, whereby the asymmetrical bridge offsets the ear bud cable from the spool axis to reduce friction applied to the ear bud cable when the ear bud cable retracts or dispenses, and to provide a second level of contaminant protection.

The curved depression has two ends and a ball plunger protruding into it from each end to removably hold the hinge.

The door opens between a closed configuration and an open configuration, the curved depression has a length, and a latch disposed along the length, the latch supported on a spring which is accommodated in a latch recess, the latch engages the hinge to selectively hold the door in an open configuration or in a closed configuration.

The door includes a detent hole configured on the hinge for receiving the latch, whereby the latch and the detent hole cooperate to release the door from the housing upon impact or pressure and thereby to protect the door from damage.

The hinge has a partially cylindrical shape having two ends and a length, the hinge being configured with an axial hole on each end thereof, and the detent hole configured on its length for engaging the ball plungers, and the latch respectively.

The retraction mechanism includes a spring mounted centrally within the spool and an annular retainer circumscribing the spool to align the ear bud cable on the spool.

The housing includes a pawl latch and switch assembly which normally engages the spool and an actuation of switch causes the pawl latch to release the spool to enable rotation of the spool and to enable retraction of the ear bud cable.

In one embodiment of the invention, the curved depression is configured on the asymmetrical bridge.

Preferably, the cover is made of a translucent plastic material, such as polycarbonate and the door is made of a transparent plastic material, such as clear polycarbonate. The ball plunger is made of a polymeric material, but could also be made of a metal such as steel.

In another embodiment of the invention, the case assembly has a housing having a cover and a door with a hinge for removably attaching it to the cover; the cover including a side to define a curved depression for removably holding the hinge; the hinge has a partially cylindrical shape having two ends and a length, the hinge being configured with an axial hole on each end thereof for engaging a respective ball plunger and a detent hole configured on the length for engaging the latch; a retraction mechanism including a rotatable spool having an axis, and an ear bud cable mounted in the housing, the retraction mechanism retracts and dispenses the ear bud cable; at least one ear bud attached to the ear bud cable; a wireless receiver mounted on the housing for receiving audio signals and the wireless receiver being in electronic communication with the ear bud cable to communicate audio signals to at least one ear bud.

In this embodiment, the housing includes an asymmetrical bridge supporting a breakaway mechanism for detaching the door from the cover and the breakaway feature includes a pair of ball plungers supported on a respective spring on each side of a curved depression configured on the cover and includes a latch supported on a spring on the length of the curved depression having a latch recess on its length.

The break-away mechanism includes ball plungers protruding through a respective axial hole configured on each end of the curved depression to engage with the respective holes configured on the hinge at each end thereof to selectively hold the door in an open configuration or in a closed configuration.

The door includes a detent hole configured on the hinge for receiving the latch, whereby the latch and the hinge cooperate to release the door from the housing upon impact or pressure and thereby to protect the door from damage.

The retraction mechanism includes a spring mounted centrally within the spool and an annular retainer circumscribing the spool to align the ear bud cable on the spool.

The housing includes a pawl latch and switch assembly which normally engages the spool and an actuation of switch causes the pawl latch to release the spool to enable rotation of the spool and to enable retraction of the ear bud cable.

The method of operating a retractable ear bud module of an electronic device, the method comprises the steps of: inserting finger/s in the handle recess provided on the door of the device; lifting the door till the latch fully retracts into the latch recess provided on the cover; pressing the switch of the pawl latch and switch assembly for releasing the pawl latch from the spool to enable rotation of the spool to retract the ear bud cable inside the housing.

By pulling the ear bud cable, the spool spring is wound again and the compression spring of the pawl and switch assembly pushes back the switch radially away thereby engaging the pawl into the notch on the spool, in order to dispense and keep the ear bud cable out of the case.

### BRIEF DESCRIPTION OF THE DRAWINGS

The present invention is described in terms of various examples as set forth in the drawings, in which:

FIG. 1 is a perspective view of a retractable ear bud mechanism attached to a case for an electronic device in accordance with the present invention.

FIG. 2 is a perspective view of the retractable ear bud mechanism having a hinged cover in a closed configuration.

FIG. 3 a perspective view of the retractable ear bud mechanism of FIG. 2 having the hinged cover in an open configuration.

FIG. 4 is a perspective view of an embodiment of the retractable ear bud mechanism with a port removed to display the spool of the present invention.

FIG. 5 is a cutaway perspective view of the retractable ear bud mechanism as seen along the line 5-5 of FIG. 2.

FIG. 6 is an exploded perspective view of the retractable ear bud mechanism of FIG. 4.

FIG. 7A shows a perspective view of another embodiment of the electronic device mounted on a case in accordance with the present invention. The case is covered by a cover made of a translucent plastic material and a hinged door configured with a door mechanism for its opening and closing.

FIGS. 7B and 7C show two perspective side views of the device shown in FIG. 7A.

FIG. 7D shows an exploded view of the device shown in FIG. 7A.

FIG. 8A shows a perspective view of the device shown in FIG. 7C with its door in an opened condition with ear bud cable fully retracted inside.

FIG. 8B shows an enlarged perspective view of the device shown in FIG. 8A with its door removed to show break-away features provided thereon.

FIG. 8C shows a detailed view of the separated door showing the corresponding break-away features provided thereon.

FIG. 9A shows yet another embodiment of the electronic device in accordance with the present invention having an asymmetrical bridge mechanism for preventing any damage to the cable during movement by minimizing friction and any possible damage to the microphone fixed on the ear bud cable, which is shown in an extended position.

FIG. 9B shows the view of the asymmetrical bridge mechanism showing the ball plungers and ball plunger latch and the springs supporting them in an assembled condition.

FIG. 9C shows another front view of the asymmetrical bridge mechanism showing the ball plungers and ball plunger latch and the springs in another position thereof.

FIG. 9D shows another view of the electronic device shown in FIG. 9A with the ear bud assembly in a retracted position, however without the asymmetrical bridge.

### DETAILED DESCRIPTION OF THE DRAWINGS

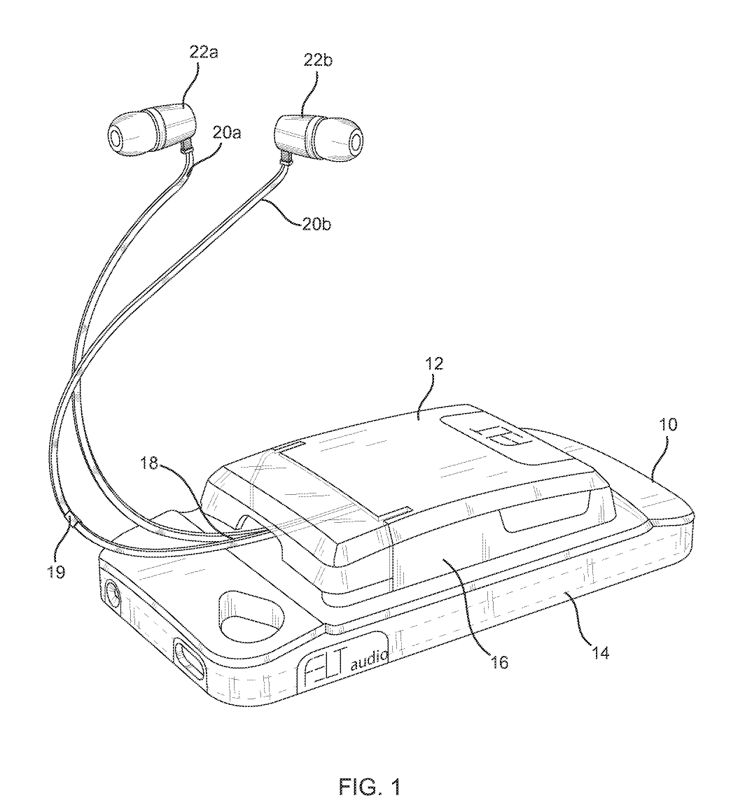

FIG. 1 shows a case 10 in accordance with the present invention and a ear bud module 12. The ear bud module 12 removably attaches to the case 10. The case 10 holds electronic device 14 having an audio output capability. The electronic device 14 is preferably a telephone, the music player smart phone, a tablet computer, or other computing device having audio output capability.

In a preferred embodiment, the electronic device 14 is enabled with wireless audio output capability, for example a Bluetooth™ communication module having a radio and a processor, where the radio transmits and receives audio signals via a host-less Bluetooth™ communication protocol such as defined by the trade organization, Bluetooth SIG, and other trade organizations.

The ear bud module 12 removably attaches to the case 10. This removable attachment can include a clipped attachment that includes a press-fit between the ear bud module 12 and the case 10. In an alternate embodiment of the invention the ear bud module 12 slidably connects to the case 10. The use of a user actuated switch supplements the press-fit and slideable connection between the ear bud module 12 and the case 10 to enable a locking connection between the case 10 and the ear bud module 12.

The ear bud module 12 includes a housing 16 and an ear bud cable 18, which retractably holds an ear bud cable 18. The ear bud cable 18 has free ends 20a and 20b and ear buds 22a and 22b attached to the free ends 20a and 20b, respectively.

In one embodiment, the ear bud cable 18 is equipped with a microphone 19 to enable telephonic communication between the microphone 19 and an electronic device.

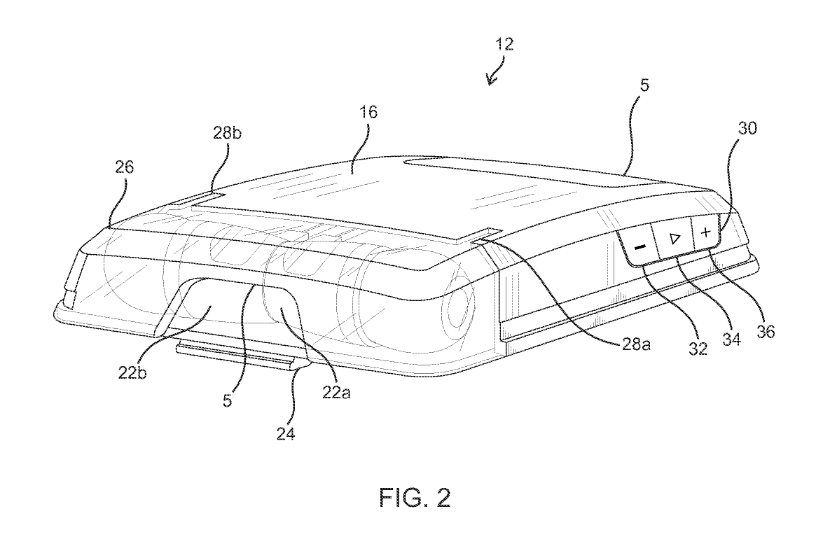

FIG. 2 shows the ear bud module generally designated with the reference numeral 12. The ear bud module 12 includes at least one clip 24 for removably attaching the ear bud module 12 to a case. Preferably, the ear bud module 12 has more than one clip 24. The ear buds 22a and 22b are shown in a retracted configuration.

The ear bud module 12 has a cover 26 mounted on the housing 16 for covering the ear buds 22a and 22b when the ear buds 22a and 22b are retracted. The cover 26 is shown closed on the housing 16. The cover 26 has two hinges 28a and 28b that assure alignment of the cover 26 on the housing 16 when the cover 26 is closed, and to enable the cover 26 to open. Preferably the cover 26 is made from transparent material to reveal the ear buds 22a and 22b when the cover 26 is closed.

The housing 16 includes a control switch 30, which includes a down volume actuator 32, and up volume actuator 36 and a skip actuator 34. The volume actuators regulate the volume of sound communicated to the ear buds 22a and 22b. The skip actuator 34 enables a user to selectively bypass an audio file when a series of audio files are streamed to the ear bud module 12 from an electronic device.

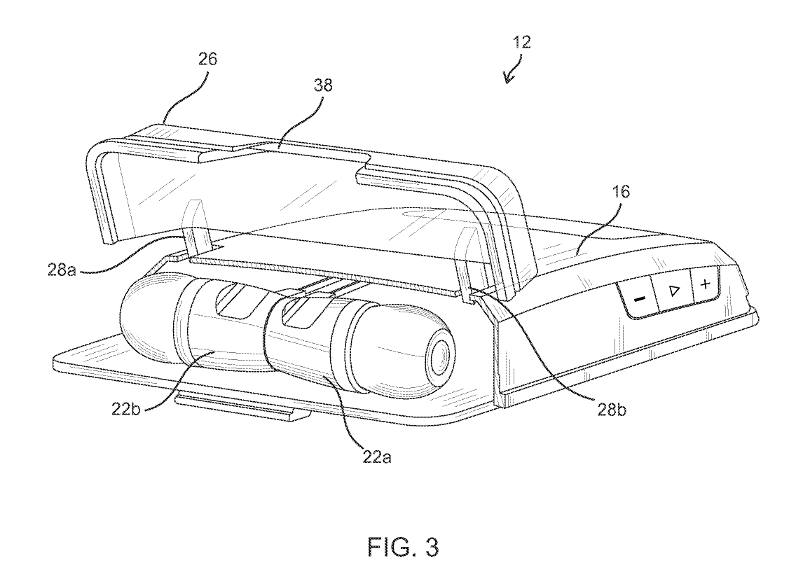

FIG. 3 shows the ear bud module 12 with the cover 26 open. The cover 26 has a handle 38 to enable a user to open and close the cover 26. As shown the handle 38 includes a recess defining an opening in the cover 26 sized to enable the finger of a user to insert into the cover 26 to grip and open the cover 26. The hinges 28a and 28b restrict the cover 26 when it opens and limit the cover opening to approximately a 90 degree angle with respect to the housing 16. Restricting the angle of the cover 26 when it opens enables the hinges 28a and 28b to be shaped so the hinges 28a and 28b only minimally protrude into the housing 16 during movement. Thus the hinges 28a and 28b are designed to minimize potential interference between the cover 38 and the ear buds 22a and 22b.

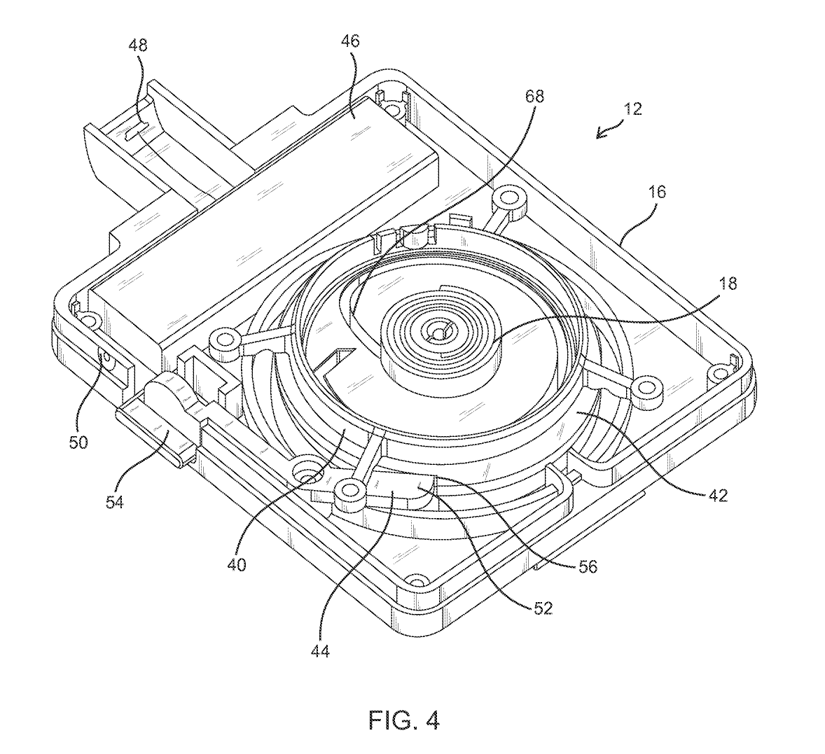

FIG. 4 shows the ear bud module 12 with a portion of the housing 16 removed.

The retraction mechanism 40 and the spool 42 enable the ear bud cable 18 to wrap around the spool 42 for stowing and dispensing the ear bud cable 18. The ear bud cable 18 is a flat cable to minimize tangles and to maximize stowage capacity of the spool 42.

The pawl latch and switch assembly 44 normally engages the spool to enable the spool to extend a desired length of ear bud cable 18. The pawl latch and switch assembly 44 includes a pawl latch 52 and a switch 54. The switch 54 selectively disengages the pawl latch 52 from the spool 42. The spool 42 includes a notch 56 that normally engages with the pawl latch 52 and cooperates with the pawl latch 52 to inhibit retraction of the ear bud cable 18. Actuation of the switch 54 releases the pawl latch 52 from the spool notch 56 to enable the spool to retract and stow the ear bud cable 18.

The pawl latch 52 and the switch 54 are a unitary structure to form the pawl latch and switch assembly 44, which pivotally mounts in the housing 16.

The charging port 48 enables recharging of the battery 46. The battery 46 powers a wireless communication module integrated in the housing 16, which wirelessly communicates with an electronic device. The power switch 50 selectively enables operation of the wireless communication module.

The spool 42 defines a slot 68 that enables the ear bud cable 18 to extend through the spool 42. The slot 68 has a spiral shape to enable the ear bud cable 18 to extend through the spool from a top level to a bottom level of the spool. The spiral shape enables the ear bud cable 18 to form slack that readily slides through the slot 68 when the ear bud cable is dispensed and retracted.

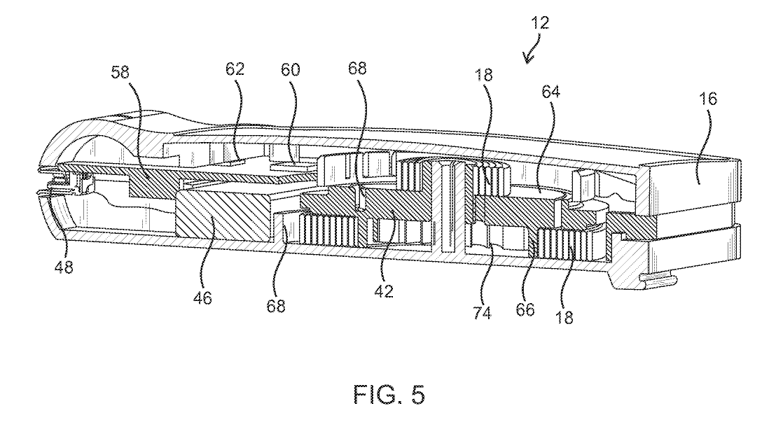

FIG. 5 shows a cutaway view of the ear bud module 12 as seen along the line 5-5 of FIG. 2. The ear bud module 12 includes the charging port 48 electrically connected with the battery 46 via a circuit board 58. The circuit board includes a processor 60 and a wireless receiver 62. The wireless receiver 62 includes a circuit board having various circuitries including a Bluetooth™ radio for transmitting and receiving signals from an electronic device equipped with Bluetooth™ capability. It can be appreciated that the wireless receiver 62 can be readily adapted to communicate via various other protocols to enable wireless communication between an electronic device and the ear bud module 12. These protocols can include UHF near field communication protocols, infrared communications protocols and other protocols capable of enabling two-way communication between an electronic device and an ear bud module. Instructions, in addition to audio signals, are communicated between the electronic device 14 (FIG. 1) and the ear bud module 12.

The ear bud cable 18 has a middle portion that wraps around a top level 64 of the spool 42 and the middle portion also wraps around the bottom level 66 of the spool 42. The spool 42 is configured with at slot 68 situated between the top level 64 and the bottom level 66 to enable the ear bud cable 18 to feed between the top level 64 and the bottom level 66 of the spool 42. As the spool 42 unwinds ear bud cable 18 slackens in the top portion 64, releasing additional length of ear bud cable 18 to the bottom level 66.

The retraction mechanism 40 includes the spool 42 and a retainer 70. The retainer 70 circumscribes the middle portion of the ear bud cable 18 that wraps around the spool 42. The retainer 70 mounts in the housing 16 with screws to retain the spool 42 in the housing and maintain alignment of the spool 42 in the housing 16.

The ear bud cable 18 has a fixed end 19 that is hard wired to the circuit board 58 to assure integrity of the audio signals communicated from the wireless receiver 62 of the circuit board 58 to the ear buds 22a and 22b (FIG. 1). Preferably the hard wired connection between the circuit board 58 and the fixed end 19 is a solder joint. Although a hard wired connection between the fixed end 19 of the ear bud cable 18 and the circuit board 58 is described, alternate connections are possible; including a plug or other mechanism for interconnecting an ear bud cable 18 to a circuit board 58 that assures signal integrity can be used.

The spool 42 includes a recessed portion on the bottom level 66 of the spool 42 which holds a spring 74. The spring 74 is recessed in the spool 42 to minimize height of the housing 16. A portion of the ear bud cable 18 wraps around the bottom portion 66 of the spool 42 and circumscribes the spring 74. The arrangement of the ear bud cable 18 circumscribing the spring 74 on the bottom level 66 of the spool 42 minimizes height of the ear bud module.

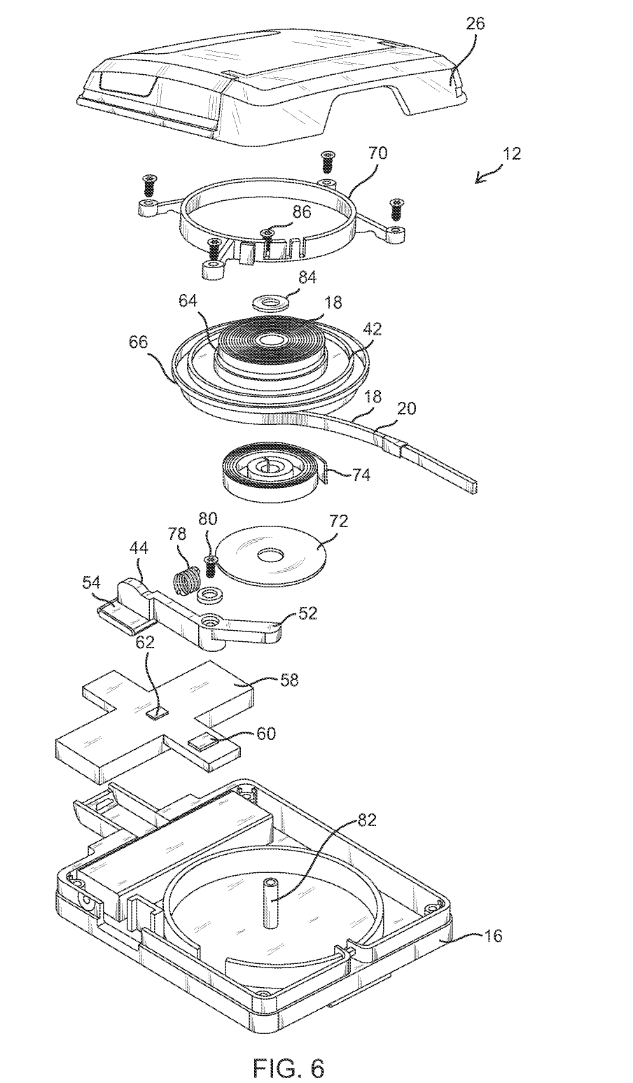

FIG. 6 is an exploded view of the ear bud module 12 of FIG. 4, including the housing 16, the circuit board 58 with the wireless receiver 62, the pawl latch and switch assembly 44, a spring retainer 72, the spring 74, the ear bud cable 18, the spool 42, and the cover 26.

The spring retainer 72 is an annular plate that enables the spring 74 to slide freely when it coils and uncoils to rotate the spool 42.

The pawl latch and switch assembly 44 includes an actuator spring 78 and screw 80 that cooperate to bias the pawl latch and switch assembly 44 in a locking orientation to inhibit retraction of the ear bud cable 18 and counter-rotation of the spool 42. Counter-rotation of the spool 42 retracts the ear bud cable 18. Actuation of the switch 54 releases the paw latch 52 from the spool to enable the spring 74 to counter-rotate the spool 42 and thus enable retraction of the ear bud cable 18.

The housing 16 includes an axle 82 that is formed in the housing 16 to receive the spool 42. A screw 86 and retainer 84 cooperate to screw the spool 42 on the axle 82 to hold the spool 42 in a fixed axial orientation, while enabling the spool 42 to rotate about the axle 82.

Further, an embodiment of the electronic device is discussed below in accordance with the present invention, in which the features similar to the previously described embodiment are added with a prefix 1, e.g. for the feature electronic device 10 of the earlier embodiment, the electronic device in this embodiment is indicated as 110, and the same applies for other common features present in this embodiment.

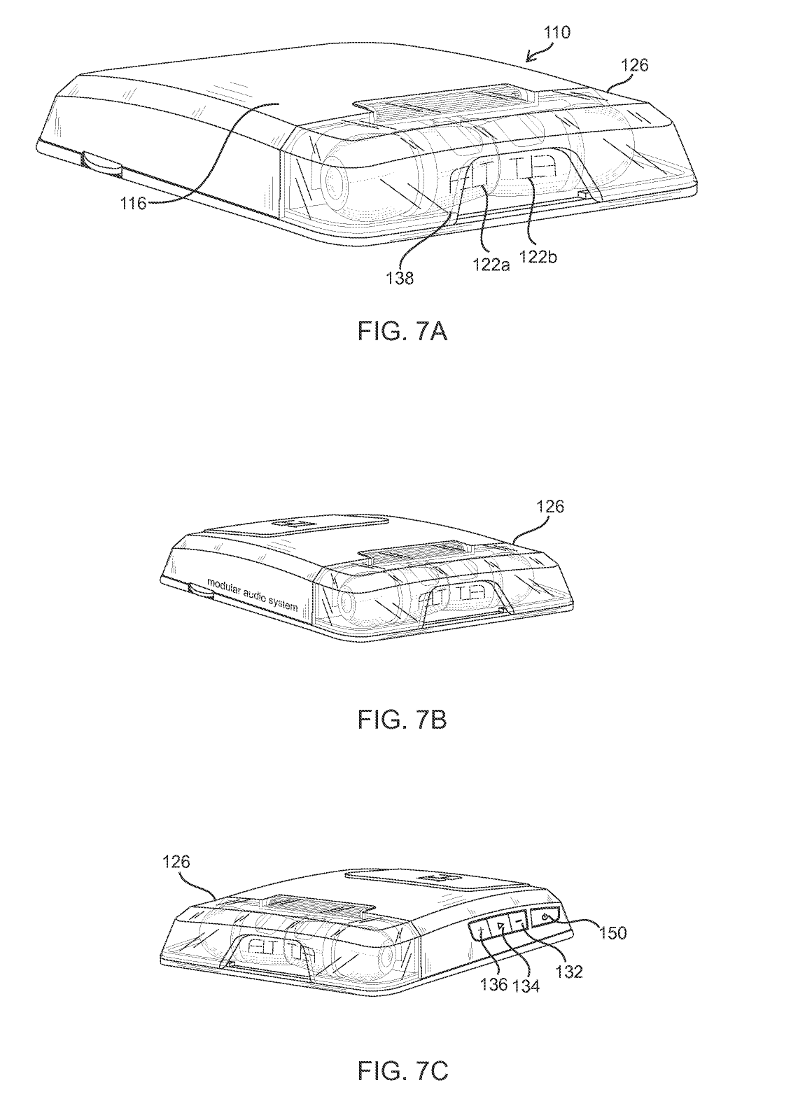

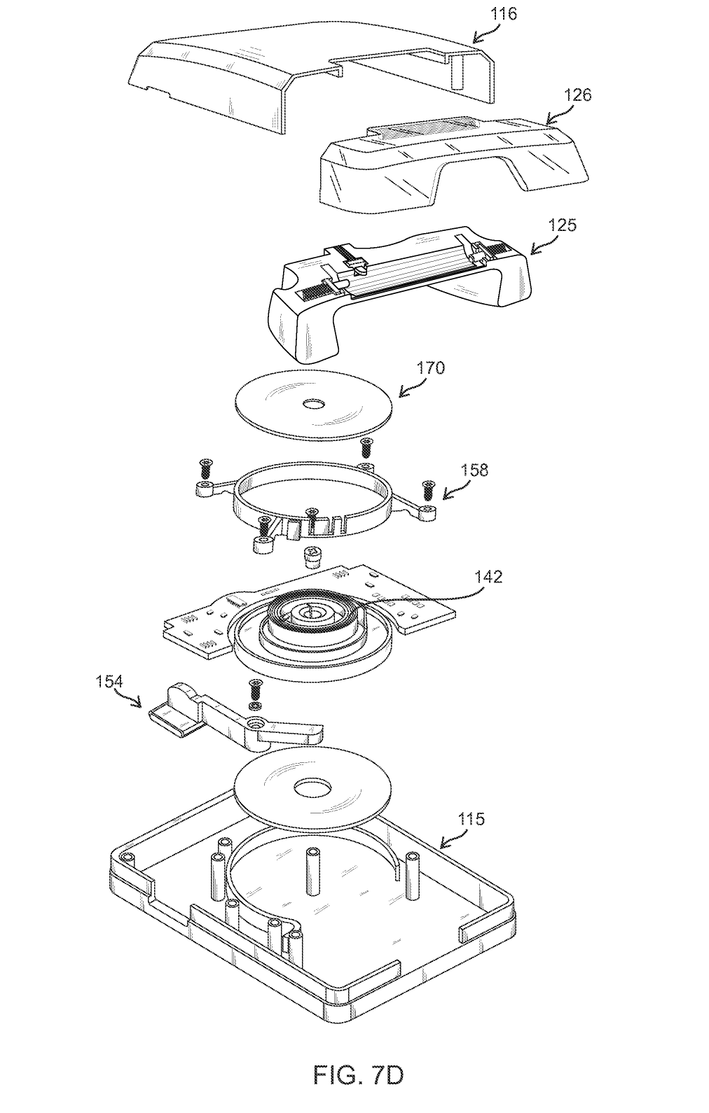

FIG. 7A shows a perspective view of the electronic device 110 in accordance with this embodiment of the present invention. It includes a protective cover 116 made of a translucent plastic material, preferably made of polycarbonate, through which the retractable ear buds 122a, 122b are visible. The door 126 is preferably made of a transparent plastic material such as a clear polycarbonate. The cover 116 and door 126 cooperate with each other by means of a door mechanism (to be explained subsequently) to open the door 126 for retracting the ear bud cable into the housing 115 or to close the door 126 for protecting the ear bud module and the electronic device 110 from dust and other contaminants. The door 126 also includes a handle recess 138 which can be used as a grip for opening and closing the door.

FIGS. 7B and 7C show two perspective side views of the electronic device 110 shown in FIG. 7A. In particular, FIG. 7C shows a power and control switch 150, a down (−) volume actuator 132, a skip (>) actuator 134, and an up (+) volume actuator 136.

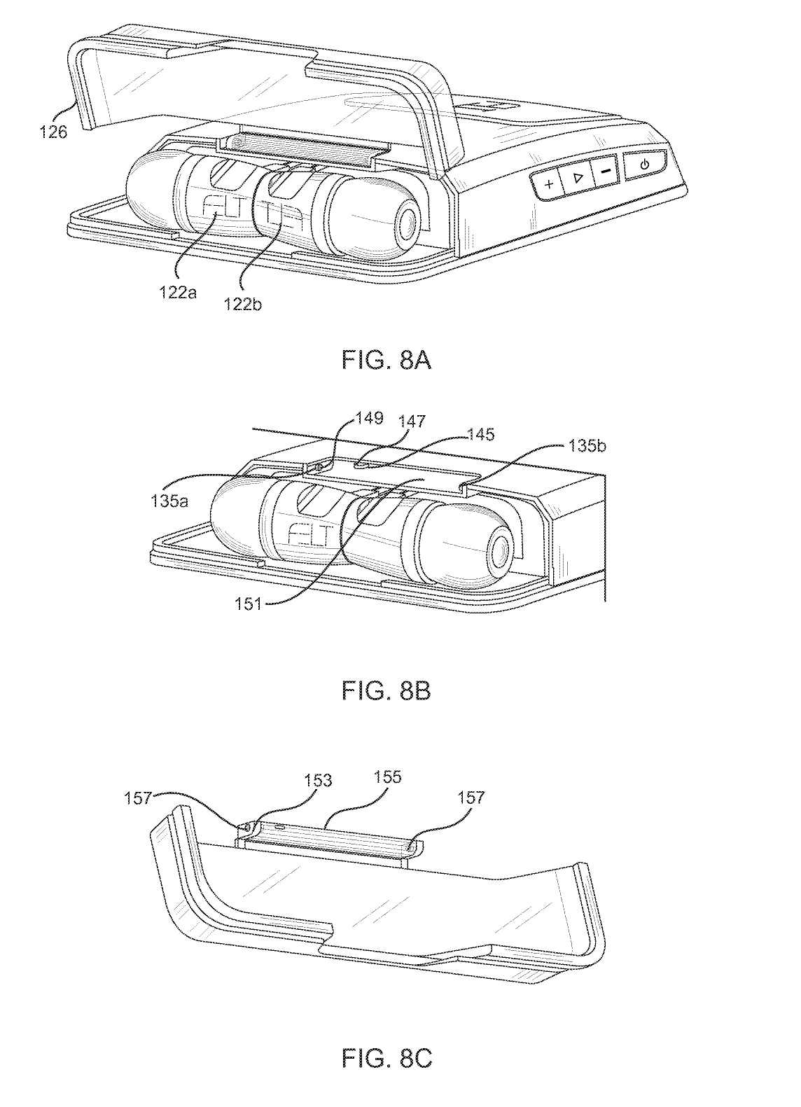

FIG. 7D shows an exploded view of the electronic device 110 shown in FIG. 7A. This includes a housing 115 covered by a cover 116 and a hinged door 126. The hinged door 126 and cover 116 are provided with a break-away mechanism (see FIGS. 8B, 8C for details). In case of an impact to the electronic device 110, this breakaway mechanism facilitates a quick separation of the door 126 from the cover 116 without causing any damage to the door 126. In its closed condition, the door 126 minimizes ingress of dust and other contaminants inside the electronic device 110, which may otherwise prove harmful to the ear bud module and the PCB assembly 158 housed inside the housing 115. The breakaway mechanism also facilitates a quick separation of the door 126 from the cover 116 even for replacing the door 126, if necessary.

An asymmetrical bridge 125 mounts inside the housing 115. The asymmetrical bridge 125 cooperates with the door mechanism and the breakaway mechanism to reduce friction and sticking of the ear bud cable 118 by maintaining the door in the open configuration when the ear bud cable is dispensed. After retraction of the ear bud cable 118 inside the housing 115, the door mechanism and the breakaway mechanism cooperate to keep the door 126 in the closed configuration, i.e. during stowage and non-use of the ear bud cable 118.

The asymmetrical bridge 125 is large enough for feeding therethrough both the ear bud cable 118 and the microphone 119 (not shown here) attached thereto. The asymmetrical bridge 125 minimizes the friction to prevent any damage to the ear bud cable 118 and the microphone 119.

In a fully retracted condition of the ear bud cable 118, the microphone 119 is positioned at a tangential position on the cable spool 142 and is located just behind the asymmetrical bridge 125. The asymmetrical bridge 125 aligns the ear bud cable 118 with that side of the spool 142 from where the ear bud cable 118 is fed into the spool 142 during retraction thereof. For this purpose, the asymmetrical bridge 125 offsets the ear bud cable 118 from the spool axis to reduce friction applied to the ear bud cable 118 when the ear bud cable retracts and dispenses. A retainer 170 is also shown, which circumscribes the middle portion of the ear bud cable 118 wrapped around the spool 142.

The printed circuit board assembly 158 shown here carries all the electronic components and wirings/connections thereon. A button 154 is also provided for releasing the pawl latch arrangement as shown in the earlier embodiments. All these components are housed on the housing 115 as shown in this exploded view. The rest of the details of the assembly are omitted here merely for sake of brevity of the description, because these have already been explained in respect of the earlier embodiment of the invention.

FIG. 8A shows a perspective view of the electronic device 110 shown in FIG. 7C with its door 126 in an opened condition. The ear buds 122a, 122b can be seen through this opened door 126 in their retracted position, i.e. in a stowage and non-use condition thereof.

FIG. 8B shows an enlarged perspective view of the electronic device 110 shown in FIG. 8A with its door 126 removed to show the unique breakaway features provided on the cover 116 thereof. These are configured as a pair of ball plungers 135a, 135b provided on the respective sides of the cover 116 along the hinge line. In the normal position, these ball plungers 135a, 135b protrude into the curved depression 151 through the holes 149 provided on both sides thereof in order to engage the corresponding holes 153 provided on the door 126 (see FIG. 8C). The curved depression 151 is configured extending along the width of the cover 116 on a side thereof and adjacent the hinged door 126. Preferably, the curved depression 151 is configured in the middle of the width of the cover 116. Similarly, a ball plunger latch 145 is located slightly off-center between these ball plungers 135a, 135b for selectively latching the door 126 in opened or closed position. This ball plunger latch 145 also protrudes into the curved depression 151 through a latch recess 147 configured on the cover 116 and similarly selectively latches into the detent hole 157 provided on the hinge 155 of the door 126 (refer FIG. 8C). Preferably, the holes 149and latch recesses 147 are disposed on the curved depression 151 at right angled to each other. The curved depression 151 and the hinge 155 configured on the door 126 (to be explained in the following) match in shape and the hinge 155 of the door 126 can be accommodated inside the curved depression 151 to be turned around with ease for opening or closing the door 126.

FIG. 8C shows a detailed view of the door 126 separated from the cover 116 of the housing 115 of the electronic device 110. It shows the corresponding break-away features provided on the door 126. These include a hinge 155 provided with holes 153 at both ends 160a, 160b thereof. The corresponding pair of ball plungers 135a, 135b shown in FIG. 8B along the hinge line protruding into the curved depression 151 engages the door 126 through these holes 153. A detent hole 157 is also provided on this hinge 155 of the door 126. The ball plunger latch 145 protrudes through the latch recess 147 into the hinge 155 of the door 126 in order to selectively engage the door 126 for opening or closing it for retracting and stowing the ear bud cable 122a, 122b of the electronic device 110 inside the housing 115. These ball plungers 135a, 135b also facilitate a quick replacement of the door 126, if necessary.

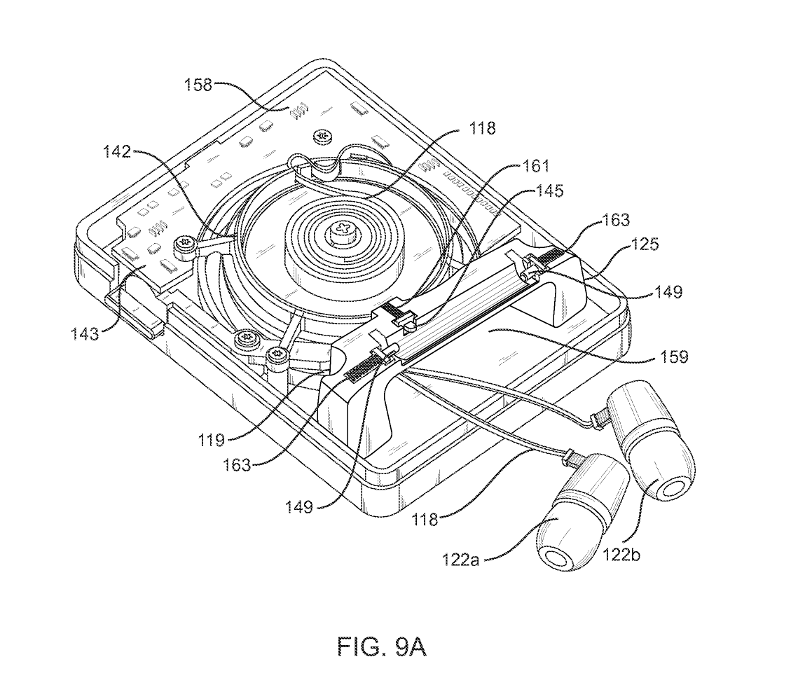

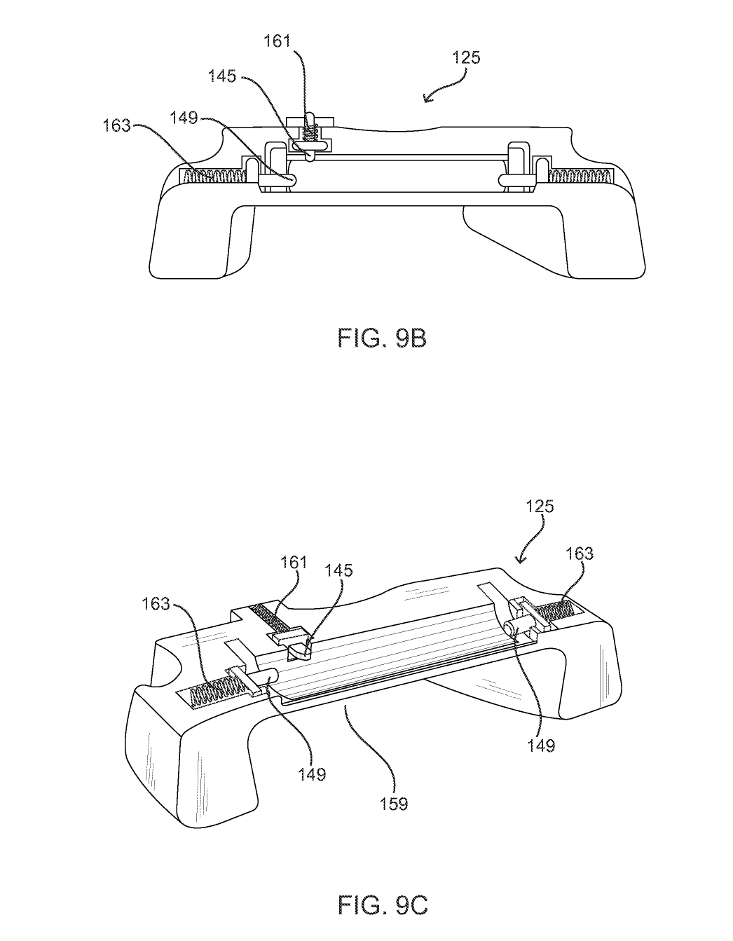

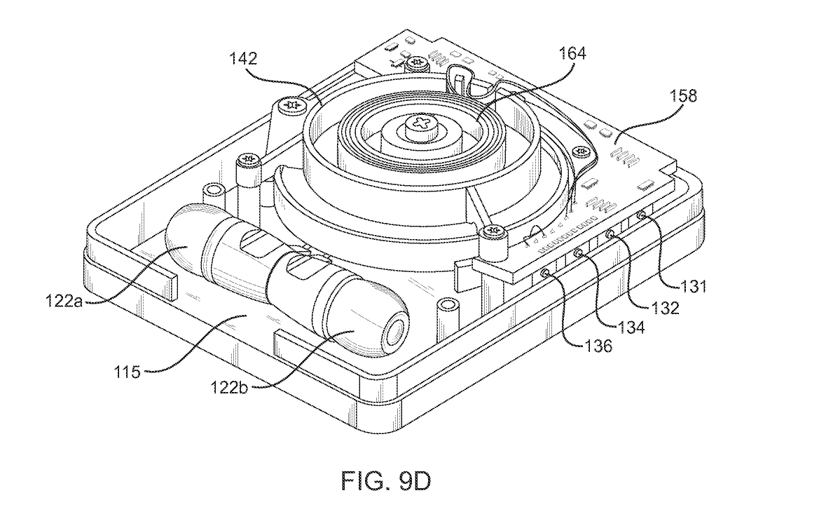

FIG. 9A shows another view of the electronic device 110 in accordance with the present invention after removing the cover 116 and door 126 for showing in detail assembly of various components/sub-assemblies of the electronic device 110 mounted on housing 115. Asymmetrical bridge 125 is also shown with a breakaway mechanism assembled and supported on it. These mechanisms prevent any damage to the ear bud cable 118 during its movement by minimizing the friction and also prevent any possible damage to the microphone 119 fixed thereon. Here, the PCB assembly 158 with a BT antenna 143 is shown. A part of the ear bud cable 118 is shown coiled within a spool 142 and the remaining ear bud cable 118 along with the ear buds 122a, 122b is extending out of the electronic device 110. The location of the microphone 119 is shown to be just behind the asymmetrical bridge 125, from where the ear bud cable 118 passes into the spool 142. Arrow 159 indicates the wide space under the asymmetrical bridge 125 which is sufficient enough for ease of retraction of the ear bud cable 118 in order to reduce friction. The break-away mechanism also includes the springs 163 supporting the respective ball spring plungers 135a, 135b disposed on the respective sides of the cover 126 along the hinge line. Similarly, the spring 161 provided on the ball plunger latch 145 to be used for latching the door 126 in its opened or closed position is also shown. The breakaway mechanism is configured to be assembled on the asymmetrical bridge 125 here. However, this can also be directly assembled on the cover 116 with suitable alternative arrangements.

FIG. 9B shows the view of the asymmetrical bridge 125 with the position of the ball plunger springs 163 and ball plunger latch spring 161 provided thereon, when the door 126 is opened for feeding the ear bud cable 118 through of wide space under the asymmetrical bridge 125.

FIG. 9C shows the view of the asymmetrical bridge 125 with the position of the ball plungers 135a, 135b supported on respective springs 163 and ball plunger latch 145 supported on its spring 161 during retraction of the ear bud cable 118 into the housing 115 of the electronic device 110, when the door 126 is closed to protect it from ingress of dust and other contaminants by stowing it inside the housing 115.

The asymmetrical bridge 125 is configured such that its right leg face tapers towards the entry side of the ear bud cable 118 into the spool 142 in order to offsets the ear bud cable 118 from the axis of the spool to minimize deformation of the ear bud cable 118 during its retraction and dispensation so that the ear bud cable is fed to/from one side of the spool 142. Further, should the ear bud cable 118 become snagged and should it be pulled with unusual force, the asymmetrical bridge 125 helps to inhibit any point forces acting on the ear bud cable 118 that could deform or sever the ear bud cable 118. Accordingly, the asymmetrical bridge 125 cooperates with the spool 142 to minimize any cable damage. Additionally, the asymmetrical bridge 125 is sized appropriately to enable the effective feeding of a microphone 119, which can be attached along the ear bud cable 118 near the ear buds 122a, 122b and typically sized and configured slightly larger in diameter than the diameter of the ear bud cable 118.

It can be appreciated that the typical configuration of the asymmetrical bridge 125 described above provides an offset of the ear bud cable 118 from the opening of the door 126 to deter entry of contaminants into the housing 115. Thereby, the asymmetrical bridge 125 cooperates with the door 126 to minimize entry of dust or other contaminants into the retractable ear bud mechanism. This is important because the contaminants can increase ear bud cable friction, and dust can raise issues related to electrical reliability in the electronic circuitry of the electronic device 110.

Here, the arrow 159 shows the offset opening provided between the two sides of the asymmetrical bridge 125, which is large enough so that the ear bud cable 118 and microphone 119 do not touch the two sides of the asymmetrical bridge 125, or touch only one side with minimal pressure and friction.

While the present invention is disclosed in terms of various embodiments, including preferred embodiments, it can be appreciated that the true scope of the invention is defined only by the appended claims.

1. A retractable ear bud module, comprising:
a housing having a cover and a door with a hinge for removably attaching the door to the cover;
the cover includes a side defining a curved depression for removably holding the hinge;
a retraction mechanism including a rotatable spool having an axis, and an ear bud cable mounted in the housing, the retraction mechanism selectively retracts or dispenses the ear bud cable;
at least one ear bud attached to the ear bud cable; and
a wireless receiver for receiving audio signals, the wireless receiver being in electronic communication with the ear bud cable to communicate audio signals to at least one ear bud.

2. The retractable ear bud module as set forth in claim 1, wherein the housing includes an asymmetrical bridge for guiding the ear bud cable with respect to the spool, whereby the asymmetrical bridge offsets the ear bud cable from the spool axis to reduce friction applied to the ear bud cable when the ear bud cable retracts or dispenses.

3. The retractable ear bud module as set forth in claim 1, wherein the curved depression has two ends and a ball plunger protruding into it from each end to removably hold the hinge.

4. The retractable ear bud module as set forth in claim 1, wherein the door opens between a closed configuration and an open configuration, the curved depression has a length, and a latch disposed along the length, the latch supported on a spring which is accommodated in a latch recess, the latch engages the hinge to selectively hold the door in an open configuration or in a closed configuration.

5. The retractable ear bud module as set forth in claim 4, wherein the door includes a detent hole configured on the hinge for receiving the latch, whereby the latch and the detent hole cooperate to release the door from the housing upon impact or pressure and thereby to protect the door from damage.

6. The retractable ear bud module as set forth in claim 5, wherein the hinge has a partially cylindrical shape having two ends and a length, the hinge being configured with an axial hole on each end thereof, and the detent hole configured on its length for engaging the ball plungers, and the latch respectively.

7. The retractable ear bud module as set forth in claim 6, wherein the retraction mechanism includes a spring mounted centrally within the spool and an annular retainer circumscribing the spool to align the ear bud cable on the spool.

8. The retractable ear bud module as set forth in claim 7, wherein the housing includes a pawl latch and switch assembly which normally engages the spool and an actuation of switch causes the pawl latch to release the spool to enable rotation of the spool and to enable retraction of the ear bud cable.

9. The door mechanism as set forth in claim 1, wherein the curved depression is configured on the asymmetrical bridge.

10. The retractable ear bud module as set forth in claim 1, wherein the cover is made of a translucent plastic material, such as polycarbonate.

11. The retractable ear bud module as set forth in claim 1, wherein the door is made of a transparent plastic material, such as clear polycarbonate.

12. The retractable ear bud module as set forth in claim 1, wherein the ball plunger is made of a polymeric material.

13. The case assembly of an electronic device with a retractable ear bud module mounted therein, the case assembly comprising:
a housing having a cover and a door with a hinge for removably attaching it to the cover; the cover including a side to define a curved depression for removably holding the hinge;
the hinge has a partially cylindrical shape having two ends and a length, the hinge being configured with an axial hole on each end thereof for engaging a respective ball plunger and a detent hole configured on the length for engaging the latch;
a retraction mechanism including a rotatable spool having an axis, and an ear bud cable mounted in the housing, the retraction mechanism retracts and dispenses the ear bud cable;
at least one ear bud attached to the ear bud cable;
a wireless receiver mounted on the housing for receiving audio signals and the wireless receiver being in electronic communication with the ear bud cable to communicate audio signals to at least one ear bud.

14. The case assembly as set forth in claim 13, wherein the housing includes an asymmetrical bridge supporting a breakaway mechanism for detaching the door from the cover and the breakaway feature includes a pair of ball plungers supported on a respective spring on each side of a curved depression configured on the cover and includes a latch supported on a spring on the length of the curved depression having a latch recess on its length.

15. The case assembly as set forth in claim 14, wherein the break-away mechanism includes ball plungers protruding through a respective axial hole configured on each end of the curved depression to engage with the respective holes configured on the hinge at each end thereof to selectively hold the door in an open configuration or in a closed configuration.

16. The case assembly as set forth in claim 13, wherein the door includes a detent hole configured on the hinge for receiving the latch, whereby the latch and the hinge cooperate to release the door from the housing upon impact or pressure and thereby to protect the door from damage.

17. The case assembly as set forth in claim 13, wherein the retraction mechanism includes a spring mounted centrally within the spool and an annular retainer circumscribing the spool to align the ear bud cable on the spool.

18. The case assembly as set forth in claim 13, wherein the housing includes a pawl latch and switch assembly which normally engages the spool and an actuation of switch causes the pawl latch to release the spool to enable rotation of the spool and to enable retraction of the ear bud cable.

19. A method of operating a retractable ear bud module of an electronic device, the method comprises the steps of:
inserting finger/s in the handle recess provided on the door of the device;
lifting the door till the latch fully retracts into the latch recess provided on the cover;
pressing the switch of the pawl latch and switch assembly for releasing the pawl latch from the spool to enable rotation of the spool to retract the ear bud cable inside the housing.

20. The method as set forth in claim 19, wherein by pulling the ear bud cable, the spool spring is wound again and the compression spring of the pawl and switch assembly pushes back the switch radially away thereby engaging the pawl into the notch on the spool, in order to dispense and keep the ear bud cable out of the case.

21. A retractable ear bud module, comprising:
a housing having a cover and a door with a hinge for removably attaching the door to the cover;
the cover includes a side defining a curved depression for removably holding the hinge;
a retraction mechanism including a rotatable spool having an axis, and an ear bud cable mounted in the housing, the retraction mechanism selectively retracts or dispenses the ear bud cable;
at least one ear bud attached to the ear bud cable; and
an asymmetrical bridge for guiding the ear bud cable with respect to the spool, whereby the asymmetrical bridge offsets the ear bud cable from the spool axis to reduce friction applied to the ear bud cable when the ear bud cable retracts or dispenses.

22. The retractable ear bud module of claim 21, wherein the hinge includes a break-away mechanism and an axis, the curved depression includes ends with axial holes, the break-away mechanism includes ball plungers protruding through the axial holes configured on each end of the curved depression to engage with the respective holes configured on the hinge at each end thereof to selectively hold the door in an open configuration or in a closed configuration.
